(19) United States
(12) Patent Application Publication
(10) Pub. No.: US 2025/0096718 A1
(43) Pub. Date: Mar. 20, 2025

(54) Aerial structure using photovoltaic panels with methods to optimize operational energy consumption, optimize renewable energy collection and reduce structural damage.

(71) Applicant: Nasr Preston Abdul-Mujeeb, Northville, MI (US)

(72) Inventor: Nasr Preston Abdul-Mujeeb, Northville, MI (US)

(21) Appl. No.: 18/369,980

(22) Filed: Sep. 19, 2023

(51) Int. Cl. H02S 10/40; B64C 39/02; B64D 27/24; B64U 10/30; B64U 50/31; G01S 17/933; G01S 17/95

(52) U.S. Cl. CPC H02S 10/40; B64C 39/024; B64D 27/24; B64U 10/30; B64U 50/31; G01S 17/933; G01S 17/95

(57) ABSTRACT

An aerial structure with photovoltaic (PV) panels using attached sensors, such as electronic gyroscopes, accelerometers, barometers connected to a programmable central processing unit (PCPU) programmed to maintain a pre-determined, static position and orientation using a plurality of connected motion enabling and motion stopping devices, such as multiple airfoil rotors, electric winch connected tethers, lighter-than-air filled enclosure, electric gas pumps and electric heating elements. The structure may have sensors such as LiDar, Radar, Sonar, and video sensors to detect adverse external conditions such as high winds, lightening, and heavy rains that may cause the structure to increase operational energy consumption, reduce the renewable energy collected, and cause structural damage. The sensors will be connected to the PCPU, which will activate the motion enabling devices to move the structure away from these adverse external conditions. The structure will use sensors such as ambient light sensors and photoelectric sensors to detect a reduction in light contacting the photovoltaic collectors caused by clouds or other light blocking objects. These sensors, in conjunction with the other sensor information, will signal the PCPU to activate the motion enabling devices to move the structure to a position where the light is not being blocked which will increase the renewable energy collected. The optimization of operational energy consumption and renewable energy collected, and the reduction of structural damage makes the aerial structure feasible and useful.

### FIELD

The embodiments discussed herein relate to the field of environmentally friendly structures. More specifically the embodiment relates to an aerial structure with renewable energy collection elements, sensors to detect adverse external conditions and a reduction of light being received by the renewable energy elements, motion enabling devices to move the structure away from the adverse external conditions and away from the cause of the light reduction and motion stopping devices to maintain structure in a static condition.

### BACKGROUND

The worldwide need for electrical energy is growing rapidly. Currently most electrical energy is produced by fossil fuels which negatively affect the environment and are in finite supply. The current electrical energy produced by renewal energy sources such as the sun and wind are not enough to meet the current or future demand for electricity. Furthermore, demand for electrical energy will increase in the future with the mass implementation of electric vehicles.

Currently solar panel installations are ground or roof based. Increasing solar panel implementation will help the environment by reducing the need for fossil fuels. However, land-based construction harms the environment by destroying vegetation and animal habitats and reducing CO2 capture. Aerial structures with solar panels will help the environment by increasing the use of solar panels and reducing the use of land-based construction. The aerial structure proposed will help alleviate environmental issues and help meet current and future electrical power demands.

Aerial structures with solar panels come with issues as well, such as the possibility of damage, reduced energy collection and excessive operational energy consumption due to adverse external conditions such as bad weather and blockages of sunlight which reduces energy collection. The proposed invention will address these issues and greatly mitigate them.

### DESCRIPTION OF PRIOR RELATED ART

U.S. Pat. No. 9,422,922, issued Aug. 26, 2016, to Robert Sant' Anselmo, et al, describes modular, fixed and transportable structures incorporating solar and wind generation technologies for the production of electricity. Sant' Anselmo et al do not suggest moving the structure to avoid adverse external conditions or moving the structure to avoid sunlight blocking elements.

U.S. Pat. No. 9,876,464, issued Jan. 23, 2018, to Georgy Mamdouh, describes an apparatus and method for a renewable energy system. Mamdouh does not suggest moving the apparatus to avoid adverse external conditions and maintain or improve renewable energy collection.

U.S. Pat. No. 10,469,021, issued Nov. 5, 2019, to Robert Matthew Panas, et al, describes an energy collection system using airborne energy collection vehicles. Panas et al do not suggest moving the vehicles to avoid adverse external conditions and to avoid sunlight blocking elements.

U.S. Patent document No. 2013/30306136, published on Nov. 21, 2013, describes a method and apparatus for improving the efficiency of renewable energy panels. U.S. document '136 does not suggest moving the panels to avoid adverse external conditions and to avoid sunlight blocking elements.

U.S. Patent document No. 2013/0000632, published on Jan. 3, 2013, describes a sun tracking solar power collection system. U.S. document '632 does not suggest moving the power collection system to avoid adverse external conditions and to avoid sunlight blocking elements.

U.S. Patent document No. 2011/0174365, published on Jul. 21, 2011, describes a system and method for forming roofing solar panels. U.S. document '365 does not suggest moving the panels to avoid adverse external conditions and to avoid sunlight blocking elements.

### SUMMARY

The disclosed technology is for an aerial structure, located above ground, with attached PV panels used to collect electrical energy from light. The aerial structure disclosed will have a plurality of sensors that can detect a reduction in light contacting the attached PV panels and cause the structure to move where the light contacting the PV panel increases. The disclosed structure will also have a plurality of sensors that can detect adverse external conditions approaching the structure and then cause the structure to move away from those conditions.

### BRIEF DESCRIPTION OF THE DRAWINGS

FIG. 1 illustrates an aerial structure with PV panels, a PCPU, a plurality of sensors and a plurality of motion enabling and motion stopping devices in accordance with some implementations of the disclosed technology.

FIG. 2 illustrates an aerial structure with PV panels using a plurality of sensors to detect approaching adverse external conditions and moving to Avoid those adverse external conditions in accordance with some implementations of the disclosed technology.

FIG. 3 illustrates an aerial structure with PV panels using a plurality of sensors to detect a reduction in sunlight contacting the PV panels and moving to increase the sunlight contacting the PV panels in accordance with some implementations of the disclosed technology.

FIG. 4 is a block diagram illustrating aerial structure components in accordance with some implementations of the disclosed technology.

FIG. 4a is a block diagram illustrating the components of the flight controller shown in FIG. 4

FIG. 5 illustrates a flow diagram for a process to have an aerial structure move away from adverse external conditions in accordance with some implementations of the disclosed technology.

FIG. 6 illustrates a flow diagram for a process to have an aerial structure move to increase the amount light contacting the structure in accordance with some implementations of the disclosed technology.

The techniques introduced herein may be better understood by referring to the Detailed Description in conjunction with the accompanying drawings, in which reference numerals indicate identical or functionally similar elements.

The drawings are not drawn to scale. Similarly, some components or operations may be separated into different blocks or combined into a single block for the purposes of discussion of some of the implementations of the disclosed technology. The disclosed technology is intended to cover all modification, equivalents, and alternatives falling within the scope of the disclosed technology as defined by the appended claims.

### DETAILED DESCRIPTION

Exemplary methods and systems are described herein. The word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant to be limiting. It will be readily understood that certain aspects of the disclosed methods and systems can be arranged and combined in a wide variety of different configurations, all of which are contemplated herein.

The disclosed technology includes an aerial structure (AS). In some implementations the structure comprise a plurality of photovoltaic (PV) panels to collect electrical energy from light; a plurality of motion enabling and motion stopping devices such as, but not limited to, multiple airfoil rotors, electric winch connected tethers, lighter-than-air gas filled enclosure, electrical heating elements and electric gas pumps, to enable the structure to move, to stop the structure from moving, and hold the structure in a static position; a plurality of sensors such as, but not limited to, electronic gyroscopes, accelerometers, and barometers for detecting the position and orientation of the structure in reference to the ground and the sun; a plurality of sensors such as, but not limited to, lidar, radar, sonar, airborne wind sensor and video sensors for detecting adverse external conditions such as, but not limited to, high winds, lightening, and heavy rains; a plurality of sensors such as, but not limited to, ambient light sensors and photoelectric sensors for detecting a reduction in light contacting the PV panels; a programmable central processing unit (PCPU) for processing signals from the above mentioned sensors and activating the motion enabling devices to move the structure to optimize both the operational energy consumption of the structure and the renewable energy collected, and reduce possible structural damage.

The disclosed technology is beneficial because it allows the aerial structure to be feasible and useful by optimizing the Total Energy Stored (TES) by the aerial structure. The TES dictates the amount of electrical energy stored in the energy storage devices, which will be used to power any electrical uses inside or outside the structure. The TES equals the Total Energy Collected (TEC) by the structure minus the Operational Energy Consumed (OEC) by the structure. TES=TEC−OEC. The OEC is the amount of energy used by the structure to obtain and maintain an optimal position and orientation above the ground and relative to the sun, the amount of energy needed to avoid adverse external conditions and increase renewable energy collection and the amount of energy used by sensors and electronic components on the structure. The TEC is the total energy collected by the plurality of PV panels on the structure. Minimizing OEC along with maximizing TEC will bring about the optimization of the TES.

In one exemplary implementation, the plurality of sensors used to detect adverse external conditions will allow for minimizing the OEC and maximizing the TEC by enabling the structure to avoid adverse external conditions. Adverse external conditions are conditions that happen outside the structure that could cause the structure to no longer be in the pre-determined position and orientation, cause the structure to use energy to avoid the adverse condition, cause the structure to use additional energy to remain in a static condition, damage the structure, and/or reduce or eliminate the ability to collect renewable energy. By avoiding adverse external conditions, the TES can be optimized.

In one exemplary implementation, the plurality of sensors used to detect a change in the amount of light contacting the PV panels will allow for maximizing the TEC by enabling the structure to move to a position that will increase the amount of light contacting the PV panels. This moving of the structure to increase the light contacting the PV panels can optimize the TES.

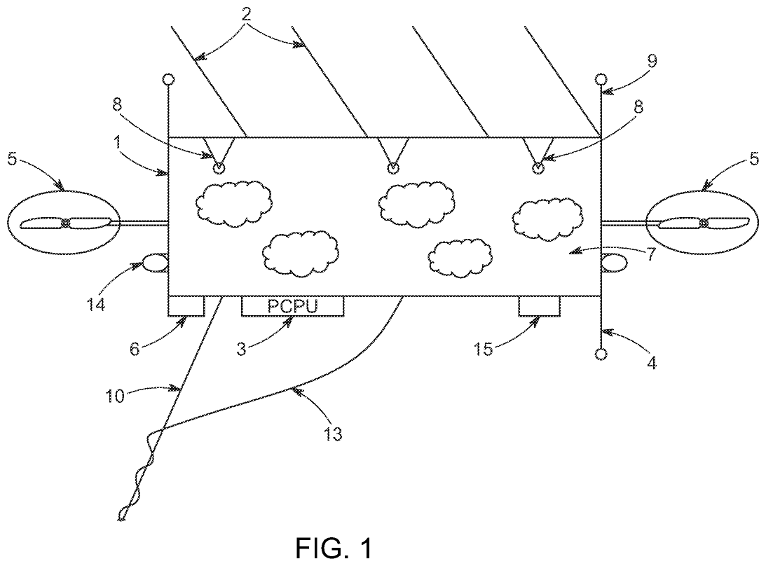

FIG. 1 illustrates an exemplary implementation of an aerial structure (1) with a plurality of photovoltaic (PV) panels (2) used to collect and transform light into electrical energy. The aerial structure can have a plurality of motion enabling and motion stopping devices, that can cause the aerial structure (1) to move, stop the structure from moving and hold the structure in place at a particular position and orientation, such as, but not limited to, multiple airfoil rotors (5), electric gas pumps with storage tanks (14), enclosures filled with lighter-than-air gas (7), electrical heating elements (8) and electric winch connected tethers (10). The aerial structure (1) can also include a plurality of sensors and sensor groups. One group of sensors will be included in the flight controller (3) module which includes a PCPU and sensors such as, but not limited to, an electronic gyroscope, accelerometer and barometer that will used to determine the structure location and orientation. Another sensor group 1 (4) may consist of, but not limited to, lidar, radar, sonar, airborne wind sensors and video sensors. The sensor group 2 (9) may consist of, but not limited to, ambient light sensors and photoelectric sensors. The aerial structure (1) may also be equipped with a global positioning system (GPS) module (6) to determine the global position of the structure.

In one exemplary implementation, the aerial structure (AS) (1) will move to a pre-determined position above the ground using the buoyancy provided by the lighter-than-air gas (LTAG) inside the enclosure (7). The AS will stop and maintain that position by achieving equilibrium between the buoyancy of the LTAG inside the enclosure and the weight of the AS. Electric gas pumps (EGP) (14) will change the weight of the AS (1). Using the EGP (14) to control the weight of the AS will allow the EGP (14) to control the vertical movement of the AS (1) relative to ground. The EGP (14) may be connected to the flight controller (3) and controlled by the PCPU with sensor inputs from the plurality of sensors inside the flight controller (3).

In one exemplary implementation, once the AS (1) is airborne, the AS (1) will be moved by multiple airfoil rotors (5) to a pre-determined position and orientation to receive the maximum light onto the PV panels (2). The position and orientation of the AS (1) may be moved from left to right, forward and backwards by a plurality of airfoil rotors (5) attached to electric motors and electronic speed controllers (ESC) which are connected to the flight controller (3) and controlled by the PCPU with inputs from the plurality of sensors inside the flight controller (3).

In one exemplary implementation, sensor group 1 (4) consisting of a plurality of sensors such as, but not limited to, lidar, radar, sonar, airborne wind sensors and video sensors, will be used to detect adverse external conditions such as, but not limited to, high winds, lightening, and heavy rains and then send a signal to the PCPU in the flight controller (3) which then activates the motion enabling devices (5, 10, & 14) in order to move the AS (1) to a position which avoids contacting the adverse external conditions.

In one exemplary implementation, sensor group 2 (9) consisting of a plurality of sensors such as, but not limited to, ambient light sensors and photoelectric sensors, which will be used to detect a decrease in light contacting the PV panels (2), then sending a signal to the PCPU inside the flight controller (3) which then, using information for sensor group 1, activates the motion enabling devices (5, 10, & 14) in order to move the AS (1) to position where the light contacting the PV panels increases.

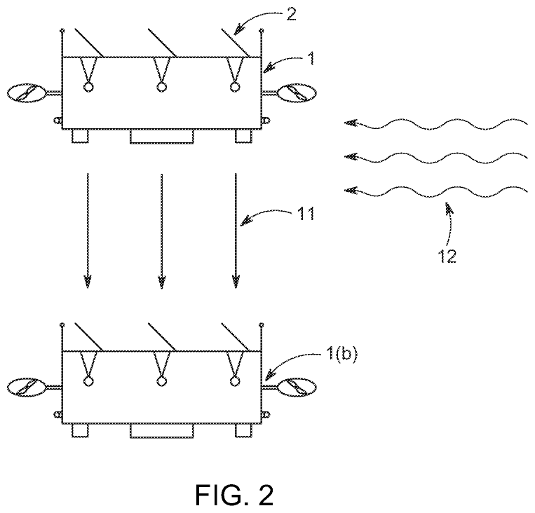

FIG. 2 illustrates an exemplary implementation of the movement (see arrows) (11) of the AS (1) when sensor group 1 (4), consisting of, but not limited to, Lidar, radar, sonar, and video sensors detect an adverse external condition such as, high winds (12) that will encounter the AS (1). The AS (1b) shows the new structure position after moving (11) to avoid contact with the adverse external condition. The movement (11) of the AS (1b) will be brought about by sensor group 1 (4) sending a signal to the PCPU inside the flight controller which then activates the motion enabling devices (5, 10, & 14) to move the AS (1b).

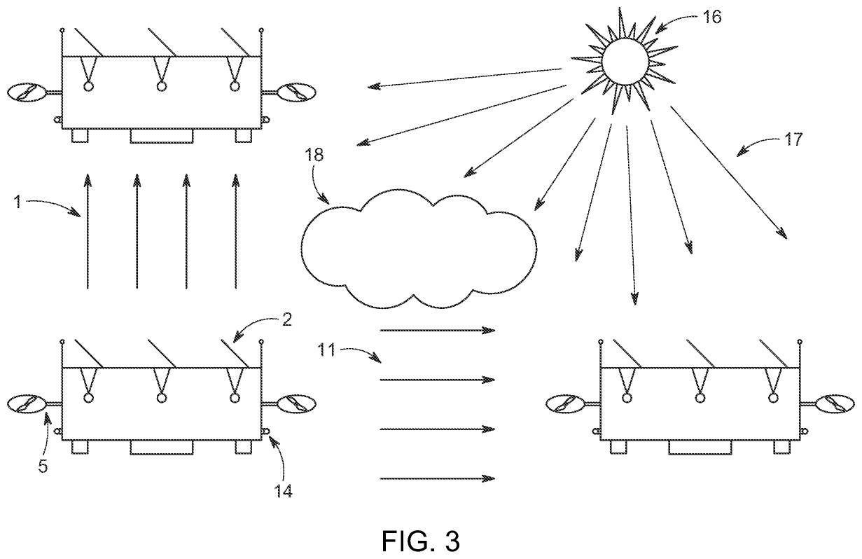

FIG. 3 illustrates in one implementation the movement (see arrows) (11) of the AS (1) when sensor group 2 (9) consisting of, but not limited to, ambient light sensors and photoelectric sensors, detect a reduction in the amount of sunlight (17) contacting the PV panels (2) on the AS (1). The sensors in sensor group 1 (4) will detect the size and location of the cause of the reduction in sunlight such as a cloud (18). The AS (1b and 1c) show the new structure position after moving (11) to avoid the cause of the reduction in sunlight (17) contacting the PV panels (2). The movement (11) of the structure will be brought about by sensor group 2 (9) sending a signal to the PCPU inside the flight controller which then, using information from sensor group 1, activates the motion enabling devices ((5, 10, & 14) to move the AS (1b).

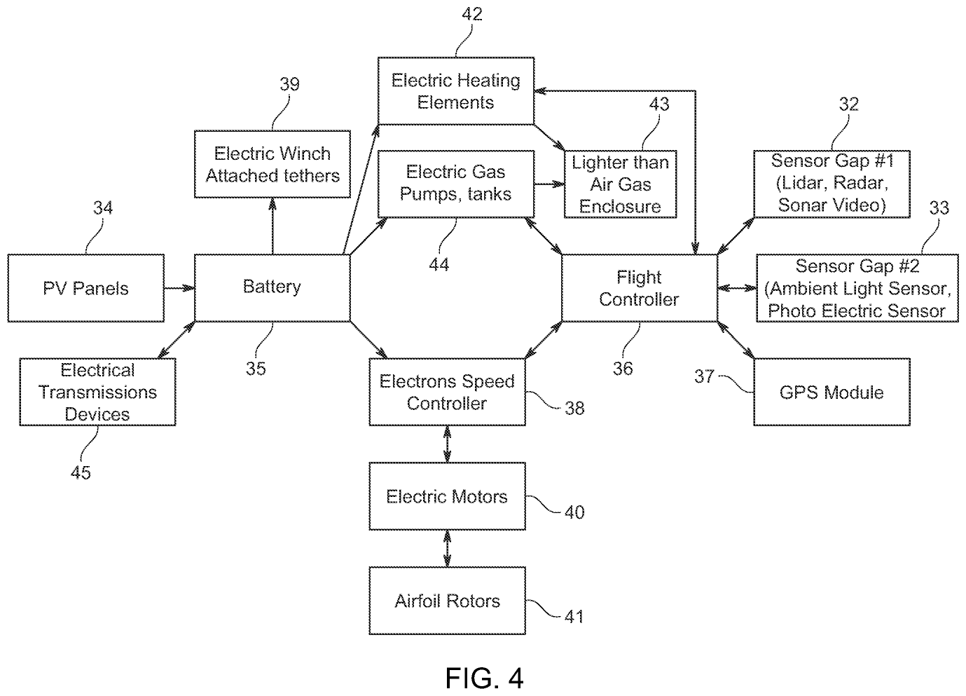

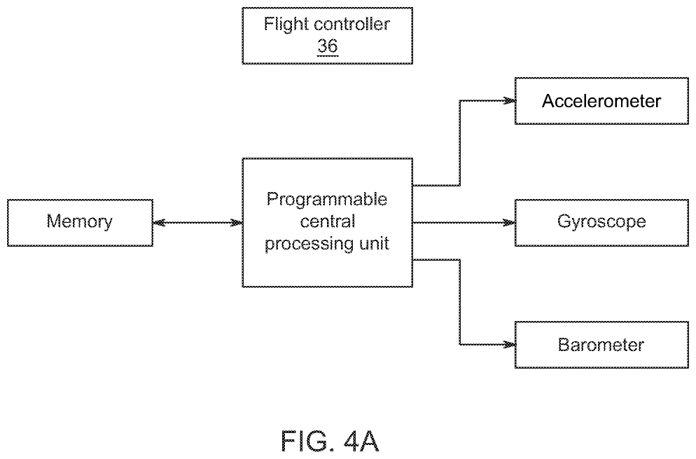

FIG. 4 is a block diagram illustrating the components of one exemplary embodiment of the AS (1). A flight controller (36) contains a PCPU and a plurality of sensors such as, but not limited to, an electronic gyroscope, accelerometer, and a barometer. The flight controller (36) can be a conventional programmable flight controller such as, but not limited to, a DJI Navi or Pixhawk. In one embodiment, connected to the flight controller may be plurality of sensors, sensor group 1 (32) and sensor group 2 (33). In sensor group 1 (32) which may contain, but not limited to, lidar, radar, sonar, and video sensors which will be used to detect adverse external conditions (AEC) and send a signal to the flight controller (36) to move the structure to avoid the AEC. In sensor group 2 (33) which may contain, but not limited to, ambient light sensors and photoelectric sensors which will be used to detect the amount of light contacting the PV panels (34) and send a signal to the flight controller (36), along with information from sensor group 1, to move the structure to increase the amount of light contacting the PV panels (34). The AS (1) will have a plurality of PV panels used to collect electrical energy from sunlight. The electrical energy will be sent to a battery (35) to be stored for use within the structure. A GPS module (37) may be connected to the flight controller (36) and used to determine the global position of the AS (1). A plurality of motion enabling and motion stopping devices such as, but not limited to, electric motors (40) connected to airfoil rotors (41), electric gas pumps (44), electrical heating elements (42), and lighter-than-air gas filled enclosure (43) and electric winch attached tethers (39), will be connected to the flight controller (36) and the battery (35) and will be used to enable the AS (1) to move, stop moving and hold the AS (1) at a certain position and orientation. The airfoil rotors (41) will be connected to the electric motors (40) and electronic speed controllers (ESC) (38) which will be connected to the flight controller (36) which will allow for the control of the left and right, forward and backward movements. The lighter-than-air enclosure (43) may have electrical heating elements (42) inserted to be used to control the buoyancy of the enclosure (43). Electric gas pumps (44) may be used to change the weight of the AS. Both the electrical heating elements (42) and the electric gas pump will be connected to the flight. controller (36) which will allow the flight controller to control the vertical movement of the AS (1).

FIG. 4a is a block diagram that illustrates the components of the flight controller (36). In this embodiment, the PCPU (36a) is a microprocessor which communicates with several other components. The PCPU (36a) may be a conventional microprocessor, microcontroller, or microcomputer. A singular or plurality of memory devices (36e) may be connected to the PCPU (36a) by a bi-directional bus for storing data and instructions to be processed by the PCPU (36a). The memory device (36e) may be, but not limited to, Dynamic Ram (DRAM) or Static Ram (SRAM) or a combination of any two or more types. An electronic accelerometer (36b), electronic gyroscope (36c), and a barometer (36d), in one embodiment, may be connected to the PCPU (36a) to communicate the PCPU (36a) the position and orientation of the AS (1).

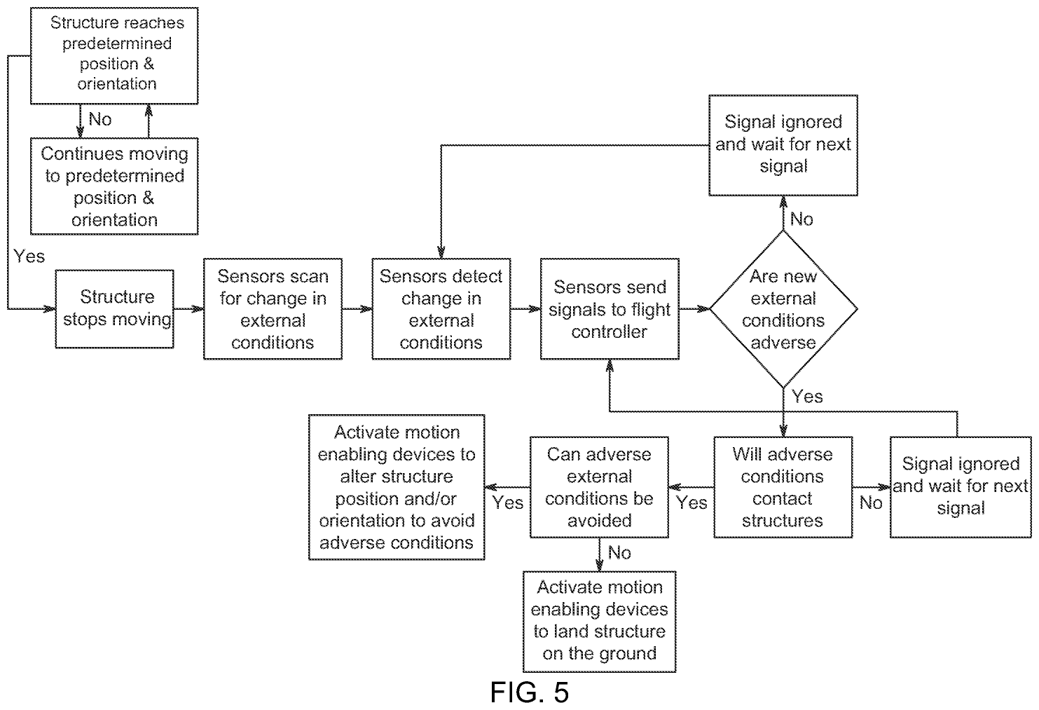

FIG. 5 illustrates a flow diagram for a process (50) to change the AS (1) position and/or orientation to avoid adverse external conditions (AEC). In one exemplary implementation, the process being with the AS (1) reaching a predetermined position and orientation above the ground and relative to the sun. Sensor group 1 (32) scan for AEC. If an AEC is detected, a signal may be sent to the flight controller, along with information about what was detected. The flight controller will then activate the motion enabling devices in order to change the position and orientation of the AS. The change in position and orientation will allow for the AS to avoid the AEC.

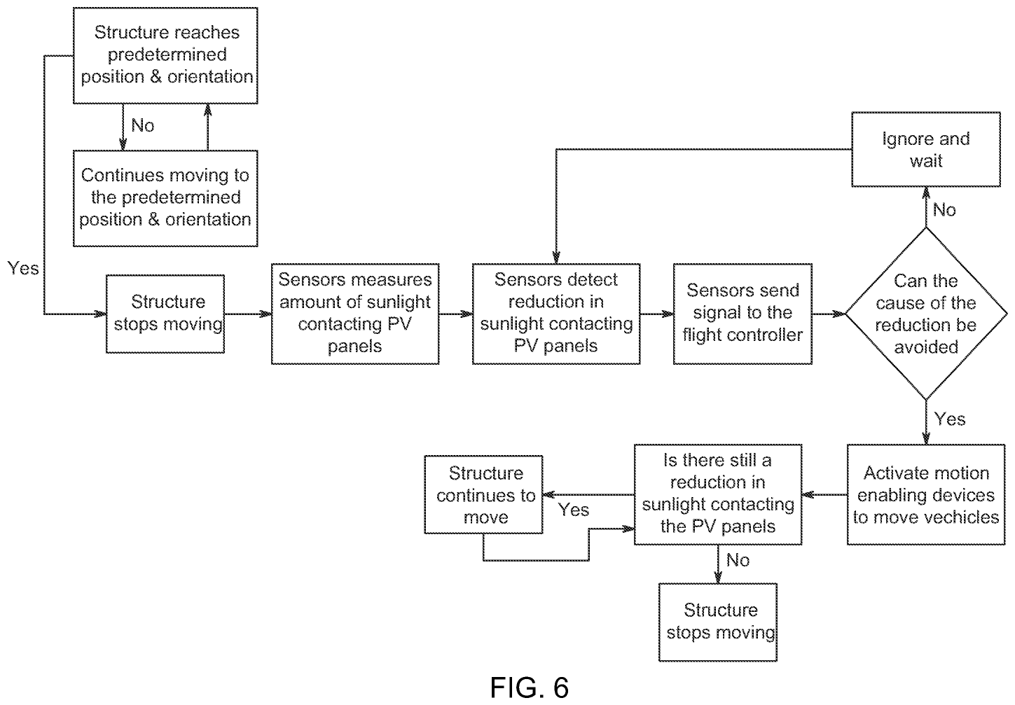

FIG. 6 illustrates a flow diagram for a process (60) to change the position and orientation of the AS in order to increase the amount sunlight contacting the PV panels. In one exemplary implementation, the process being with the AS (1) reaching a predetermined position and orientation above the ground and relative to the sun. The sensor group 2 detects a reduction in the amount of sunlight contacting the PV panels and sending a signal to the flight controller. The flight controller, with information from sensor group 1, will then activate the motion enabling devices in order to change the position and orientation of the AS. Moving the AS will increase the amount of sunlight contacting the PV panels.

### Conclusion

While a few implementations are disclosed herein, several other implementations of the disclosed technology would be clearly envisioned by those skilled in the art from the detailed description. The disclosed technology can be modified in various aspects, all without departing from the scope of the disclosed technology. For example, the electrical energy collected can be stored in the aerial structure using multiple energy storage devices such as batteries.

Reference in this specification to “one implementation” or “an implementation” means that a feature, structure, or characteristic described in connection with the implementation is included in at least one implementation of the disclosure. The appearances of the phrase “in one implementation” in various places in the specification are not necessarily all referring to the same implementation, nor are separate or alternative implementations or embodiments mutually exclusive of other embodiments. Moreover, various features are described that can be exhibited by some embodiments and not by others. Similarly, various requirements are described which may be requirements for some implementations but no other implementations.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether it is highlighted. It will be appreciated that same thing can be said in more than one way.

Consequently, alternative language and synonyms may be used for any one or more of the terms discussed herein, nor is any special significance to be placed upon whether a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various implementations given in this specification.

What is claimed is:

1. An aerial structure that can become airborne by a plurality of means comprising: an array of photo-voltaic (PV) panels, on at least one exterior surface of the structure, used to turn sunlight into electrical energy; a plurality of sensors, such as, but not limited to, LiDar, radar, sonar, airborne wind sensors and video sensors, used to detect and measure adverse external conditions, such as, but not limited to, high winds, lightening, and heavy rains, that could cause the operational energy consumption, that is necessary to maintain the structure in a static condition, to increase, the collection of renewable energy to decrease and structural damage; a programmable central processing unit (PCPU) which receives signals from the above mentioned sensors to determine where the structure should move to avoid the adverse external conditions and to optimize both operational energy consumption and renewable energy collection, and reduce possible structural damage; a plurality of motion enabling and motion stopping devices such as, but not limited to, multiple airfoil rotors, winch connected tethers, and enclosures filled with lighter-than-air gas, gas pumps and electric heating elements, which are controlled by the above mentioned PCPU and activated to cause the structure to move to avoid the adverse external conditions in order to optimize both operational energy consumption and renewable energy collection and reduce structural damage.

2. The aerial structure of claim 1 further comprising: a plurality of sensors such as, but not limited to, ambient light sensor and photoelectric sensors used to detect a change in the amount of light contacting the PV panels of claim 1 and sends a signal to the PCPU of claim 1. If that signal indicates a reduction in the amount of light contacting the photo-voltaic panels, which will indicate a reduction in the amount of renewable energy collected, the PCPU, using information from the sensors of claim 1, will then activate the motion enabling devices to move the structure to increase the amount of light contacting the photo-voltaic panels which can optimize renewable energy collection.

3. A method to optimize the operational energy consumption required to maintain the aerial structure of claim 1, in a static condition, optimize renewable energy collection of the structure and reduce possible structural damage by detecting and avoiding adverse external conditions, a method comprising: detecting with sensors adverse external conditions, once adverse external conditions are detected, a signal is sent to the PCPU and/or a human operator, which then activates the motion enabling devices. The motion enabling devices then move the aerial structure to avoid contact with the adverse external condition.

4. A method to optimize renewable energy collection of the aerial structure of claim 1, by detecting a change in light contacting the PV panels, a method comprising: detecting with sensors, a change in the light contacting the PV panels, a signal is sent to the PCPU and/or a human operator and if the signal indicates a reduction in the light contacting the PV panels, the PCPU and/or a human operator, using information from the sensors of claim 1, will activate the motion enabling devices to move the structure to increase the light contacting the PV panels and optimize renewable energy collection.
